(19) United States
(12) Patent Application Publication
(10) Pub. No.: US 2023/0139897 A1
(43) Pub. Date: May 4, 2023

(54) SOLID HERBICIDE COMPOSITION AND THE USE THEREOF

(71) Applicant: Rotam Agrochem International Company Limited, Chai Wan (HK)

(72) Inventor: James Timothy Bristow, Chai Wan (HK)

(73) Assignee: Rotam Agrochem International Company Limited, Chai Wan (HK)

(21) Appl. No.: 17/517,760

(22) Filed: Nov. 3, 2021

(51) Int. Cl. A01N 43/80; A01N 25/14

(52) U.S. Cl. CPC A01N 43/80; A01N 25/14

(57) ABSTRACT

A solid herbicidal composition containing a high content of topramezone salt and having excellent disintegration and dispersion performance is provided. The composition is in the form of a water dispersible granule. The topramezone salt can be selected from the group consisting of sodium salt of topramezone, potassium salt of topramezone, lithium salt of topramezone and ammonium salt of topramezone. The solid herbicidal composition further includes dispersant which can be selected from the group consisting of aryl sulfonate salt/ester, alkaryl sulfonate salt/ester, sulfonate salt/ester of their formaldehyde condensates, polycarboxylate, and lignosulfonate.

### TECHNICAL FIELD

The present invention relates to a solid herbicidal composition, in particular to a solid herbicidal composition having fast disintegration performance and with a high content of topramezone salts.

### BACKGROUND ART

Topramezone (English common name) with a chemical name [3-(4,5-dihydro-3-isoxazolyl)-4-methylsulfonyl-2-methylbenzene]5-hydroxy-1-methyl-1H-pyrazol-4-yl)methanone is the first pyrazolone benzoate herbicide developed by BASF and is a new type of pyrazolone-based intake transportation herbicide for post-emergence stem and leaf treatment. Topramezone and the preparation thereof are known from WO 98/31681 and WO 99/58509.

The mechanism of action of topramezone is to inhibit 4-hydroxyphenylpyruvate dioxidase (HPPD) in the biosynthesis of plastoquinone, indirectly affecting the synthesis of carotenoids and interfering with the synthesis and function of chloroplasts under light conditions, resulting in serious green fading and albino and tissue necrosis, and plants usually die after 14 days of treatment. Due to the oxidative degradation of chlorophyll, especially, the overground growing zone of sensitive weeds has the most obvious symptoms of toxication. Topramezone is absorbed by sensitive weeds through leaves and roots, and transported both up and down in plants, causing the plants to stop growing quickly. Symptoms of albino toxication appeared in the overground part of the weeds within 2-5 days after application. Growth points, leaves and veins have the most obvious symptoms of toxication. The albino tissues gradually became necrotic, and the entire plant wither to die. Depending on the weather and environment, it would take about 10-15 days from the application to death of weeds. Topramezone is safe to corn. Compared with sensitive weeds, the resistance of corn to topramezone is due to its low sensitivity to target enzymes, less absorption and transportation for topramezone, and faster metabolism. Topramezone can effectively kill annual gramineous and broadleaf weeds and cyperaceae weeds, such as crabgrass, barnyardgrass, setaria, brachiaria, goosegrass, wild millet, pennisetum, cenchrus, Cyperus difformis, Cyperus iria, amaranth, polygonum, field bindweed, cephalanoplos seyetum, goosefoots, cocklebur, Solanum nigrum, abutilon, datura, Galeopsis bifida, matricaria, ragweed, wild mustard, wild Carrots, acanthospermum, Acanthospermum hispidum, annual mercury, south american beggarweed, Emilia sonchifolia, galinsoga, nicandra, dayflower, lindernia and mazus. Topramezone can also effectively and stably control broadleaf weeds that have developed resistance to ALS and triazine herbicides.

WO 2008064988A discloses the preparation of an aqueous composition comprising a monovalent cation salt of topramezone, which can be combined with fertilizers and is compatible and stable. The content of topramezone disclosed therein is 0.005-500 g/L, preferably 10-300 g/L. However, when the pharmacist prepares the aqueous formulation of the monovalent cation salt of topramezone, it is difficult to formulate an aqueous formulation with the content of topramezone more than 300 g/L, and higher, such as more than 500 g/L due to the limitation by the influence of the water solubility of the monovalent cation salt of topramezone and ambient temperature.

WO 2008015280A discloses a concentrated solution composition of topramezone and dicamba dissolved in water in the form of alkali metal salt or ammonium salt, and the content of topramezone disclosed therein is 10-100 g/L. It is also difficult to prepare an aqueous products with a high content of topramezone.

WO 2020043470 A1 discloses an aqueous composition with a content of topramezone of 0.1%-1%. The content is lower in its special application environment.

At present, the commercialized products of topramezone are mainly liquid preparations, such as “Stellar Star”, i.e., topramezone 50 g/L+dicamba 160 g/L SL; “Armezon”, i.e., topramezone 336 g/L SC; “Armezon Pro”, i.e., topramezone 1.12%+dimethenamid-P 56.25% SE, all from BASF. The content of topramezone in these liquid preparations is relatively low. In view of the influence of various economic and environmental factors, it is necessary to prepare high-content pesticide preparation products to reduce the package quantity and transportation cost and the quantity of packaging materials that must be processed after pesticide application.

Experienced pharmacists know that a solid pesticide preparation is an ideal dosage form for preparing a preparation with a high content of pesticide active substances and a suitable solid pesticide preparation comprises, for example, dispersible granules and water-soluble granules. However, it has been found that the solid preparation with a high content of topramezone, such as the solid preparation with a content of topramezone more than 30%, especially a content of topramezone more than 40%, disintegrate poorly when diluted with water, which brings great inconvenience to users.

Therefore, the object of the present invention is to provide a solid herbicidal composition comprising topramezone, which has a relatively high content of topramezone active substances and has good disintegration. In addition, the solid herbicidal composition should be economical, environmentally friendly, convenient for transportation, and convenient for users to use.

### SUMMARY

It was surprisingly discovered that the above and other objectives are achieved by the use of the form of topramezone salts.

Therefore, the present invention provides a solid herbicidal composition comprising:

at least one topramezone salt;

at least one dispersant.

### DETAILED DESCRIPTION

The solid herbicidal composition of the present invention, which includes at least one topramezone salt and at least one dispersant, has improved disintegration performance in water, and has a fast disintegration effect after being diluted with water, so that the topramezone and/or other components in a spray liquid can disintegrate fast and disperse homogeneously. Such fast disintegration and homogeneous dispersion effects are unpredictable.

In a preferred embodiment, the present invention provides a solid herbicidal composition comprising:

35-80 wt % of the at least one topramezone salt;

1-15 wt % of the at least one dispersant.

In the solid herbicidal composition of the present invention, the topramezone salts refer to topramezone in the form of salts, such as sodium salt of topramezone, potassium salt of topramezone, lithium salt of topramezone, ammonium salt of topramezone, topramezone hydrochloride, topramezone sulfate, calcium salt of topramezone, copper salt of topramezone, isopropylammonium salt of topramezone, triethylamine salt of topramezone, etc. Especially preferred topramezone salts are sodium salt of topramezone, potassium salt of topramezone, lithium salt of topramezone and ammonium salt of topramezone. In other particularly preferred embodiments, the topramezone salts are more preferably sodium salt of topramezone, potassium salt of topramezone and lithium salt of topramezone.

The solid herbicidal composition of the present invention comprises at least 35 wt % of topramezone salts, especially at least 38 wt % of topramezone salts, particularly at least 40 wt % of topramezone salts. The preferred amount of the topramezone salts is 35-80 wt % of the solid herbicidal composition, and the particularly preferred amount of the topramezone salts is 40-70 wt % of the solid herbicidal composition.

In the solid herbicidal composition of the present invention, the dispersants are selected from one or more of aryl sulfonate salt, aryl sulfonate ester, alkaryl sulfonate salt, alkaryl sulfonate ester, sulfonate salt, sulfonate ester, sulfonate salt of a formaldehyde condensate, sulfonate ester of a formaldehyde condensate, polycarboxylate, and lignosulfonate.

The aryl sulfonate salt or aryl sulfonate ester may be referred to as aryl sulfonate salt/ester. The alkaryl sulfonate salt or alkaryl sulfonate ester may be referred to as alkaryl sulfonate salt/ester. The sulfonate salt of a formaldehyde condensate or sulfonate ester of a formaldehyde condensate may be referred to as sulfonate salt/ester of their formaldehyde condensates.

The alkyl residues in the sulfonate salt/ester used in the present invention may be linear or branched. The alkyl residues can be, for example, C1-12alkyl residues such as methyl, ethyl, propyl, butyl, pentyl, hexyl, heptyl, octyl, nonyl, decyl, undecyl or dodecyl. The aryl residues in the sulfonate salt/ester may be a monocyclic or polycyclic aryl group, such as a benzene ring or a naphthalene ring.

As the salt of the sulfonate salt/ester, various salts can be referred. The various salts may be, for example, salts of alkali metals such as sodium or potassium, or salts of alkaline earth metals such as magnesium or calcium.

The sulfonate salt/ester is preferably an alkaryl sulfonate salt/ester or formaldehyde condensate thereof, more preferably an alkylbenzene sulfonate salt/ester, an alkylnaphthalene sulfonate salt/ester, an alkylbenzene sulfonate salt/ester condensed with formaldehyde or an alkylnaphthalene sulfonate salt/ester condensed with formaldehyde, more preferably an alkylbenzene sulfonate salt/ester condensed with formaldehyde or an alkylnaphthalene sulfonate salt/ester condensed with formaldehyde.

Examples of the polycarboxylic acid moiety in the polycarboxylate used in the present invention comprises polyacrylic acid, polymethacrylic acid, copolymers of acrylic acid/maleic acid, and copolymers of acrylic acid/sulfonic acid. Examples of the salt moiety in the polycarboxylate comprises various salts, such as alkali metal salts, such as potassium salts and sodium salts; alkaline earth metal salts, such as magnesium salts and calcium salts.

The lignosulfonate used in the present invention may be, for example, salts of alkali metals such as sodium or potassium, or salts of alkaline earth metals such as magnesium or calcium.

The solid herbicidal composition of the present invention comprises at least 0.1 wt % of the above-mentioned dispersants, especially at least 0.5 wt % of the above-mentioned dispersants, particularly at least 1 wt % of the above-mentioned dispersants; The preferred amount of the above-mentioned dispersants is 1-15 wt % of the solid herbicidal composition, and the particularly preferred amount of the above-mentioned dispersants is 2-10 wt % of the solid herbicidal composition.

In addition, the solid herbicidal composition of the present invention also comprises other functional additives that are optionally agrochemically acceptable. The additives used herein may be any additives, as long as they are commonly used in this technical field, and for example, additional surfactants (surfactants other than the sulfonate salt/ester and carboxylate), carriers, binders, defoamers, desiccants, bactericides, stabilizers, colorants and the like may be referred.

The additional surfactants comprise, for example, anionic surfactants, such as fatty acid salts, benzoates, alkyl sulfosuccinates, dialkyl sulfosuccinates, polycarboxylates, salts of alkyl sulfate ester, alkyl sulfates, alkyl diethylene glycol ether sulfates, salts of alcohol sulfate ester, alkyl sulfonates, lignosulphonates, alkyl diphenyl ether disulfonates, polystyrene sulfonates, salts of alkyl phosphate ester, alkyl aryl phosphates, styryl aryl phosphates, salts of polyoxyethylene alkyl ether sulfate ester, polyoxyethylene alkaryl ether sulfates, polyoxyethylene styryl aryl ether sulfates, polyoxyethylene styryl aryl ether ammonium sulfate, salts of polyoxyethylene alkyl aryl ether sulfate ester, polyoxyethylene alkyl ether phosphates, salts of polyoxyethylene alkyl aryl phosphate ester, polyoxyethylene styryl aryl ether phosphate ester or salts thereof, phenol sulfonates condensed with formaldehyde and salts of maleic anhydride alkylene copolymers; non-ionic surfactants, such as sorbitan fatty acid esters, glycerin fatty acid esters, polyglycerol esters of fatty acids, fatty acid alcohol polyethylene glycol ethers, acetylene ethylene glycol, acetylene alcohols, alkylene oxide block polymers, Polyoxyethylene alkyl ether, polyoxyethylene alkaryl ether, polyoxyethylene styryl aryl ether, polyoxyethylene glycol alkyl ether, polyoxyethylene fatty acid ester, polyoxyethylene sorbitan fatty acid esters, polyoxyethylene sorbitol fatty acid esters, polyoxyethylene glycerin fatty acid esters, polyoxyethylene hydrogenated castor oil, polyoxyethylene castor oil and polyoxypropylene fatty acid esters; and cationic surfactants, such as alkoxylated fatty amines. If necessary, two or more of them can be suitably used in combination.

The carriers can be, for example, plant-based powders (e.g., soy flour, starch, grain flour, wood flour, bark flour, sawdust, walnut shell flour, bran, cellulose powder, coconut husk, granules from corn cob and tobacco stem, residues after extracting plant extracts, etc.), paper, sawdust, synthetic polymer of crushed synthetic resin and the like, clays (such as kaolin, bentonite, acidic china clay, etc.), talcum powder, silica (such as diatomite, silica sand, mica, hydrous silicate, calcium silicate), activated carbon, natural minerals (pumice, attapulgite and zeolite, etc.), calcined diatomite, sand, plastic media and the like (such as polyethylene, polypropylene, polyvinylidene chloride, etc.), inorganic mineral powders (such as potassium chloride, calcium carbonate, and calcium phosphate), chemical fertilizers (such as ammonium sulfate, ammonium phosphate, urea, and ammonium chloride), and soil fertilizers. According to an example embodiment, the carrier includes lactose monohydrate. If necessary, a mixture of two or more of them can be used.

Examples of the binders comprise various gums such as guar (cyamoposis) gum, locust bean gum, tragacanth, xanthan, and arabic gum; alginic acid derivatives such as sodium alginate, ammonium alginate and propylene glycol alginate; organic polymer compounds such as polyvinyl alcohol, polyvinyl pyrrolidone, polyvinyl polymethacrylate, polyethylene oxide, polyacrylic acid, sodium polyacrylate and polyacrylamide; animal or plant water-soluble proteins such as white protein, albumin, casein and gelatin; cellulose derivatives such as methyl cellulose, carboxymethyl cellulose, sodium salt of carboxymethyl cellulose, carboxyethyl cellulose, hydroxyethyl cellulose, hydroxypropyl cellulose and hydroxypropyl methyl cellulose; starches such as dextrin, starch, sodium salt of carboxymethyl starch, hydroxyethyl starch and hydroxypropyl starch; and lignosulfonic acid derivatives such as sodium lignosulfonate and calcium lignosulfonate. If necessary, a mixture of two or more of them can be used.

Suitable defoamers are one or more of silicone oil, silicone compounds, C10-20 saturated fatty acid compounds, and C8-10 fatty alcohol compounds.

Suitable bactericides are bronopol and isothiazolinone derivatives such as alkyl isothiazolinones and benzisothiazolinones.

Suitable stabilizers are those that can prevent the active ingredients from decomposing during storage, such as BHT or resorcinol.

Suitable colorants (for example red, blue or green) are low water-soluble pigments and water-soluble dyes. Examples are inorganic colorants (such as iron oxide, titanium oxide, ferric hexacyanoferrate) and organic colorants (such as alizarin colorants, azo colorants, and phthalocyanine colorants).

Generally, the amount of the functional additives in the solid herbicidal composition of the present invention is not limited, because they can vary with the amount of the topramezone salts. Under normal conditions, the amount of the functional additives is to complement the weight of the solid composition to 100% and can be any value between 0-64 wt %, preferably any value between 5-64 wt %.

In the present invention, if necessary, other herbicidal active substances other than the topramezone salts can be added, so that a more excellent effect or a synergistic effect may be exhibited in some cases. For example, herbicidal active substances whose control effect can preferably improve the range of controllable weeds, application time of the composition, herbicidal activity, etc. may be used.

Suitable herbicidal actives substances include, but are not limited to, 2,4-D, acetochlor, acifluorfen, aclonifen, alachlor, allidochlor, alloxydim, ametryn, amicarbazone, amidosulfuron, anilofos, atraton, atrazine, azafenidin, azimsulfuron, aziprotryne, barban, beflubutamid, benazolin, benfluralin, benfuresate, bensulfuron, bentazone, benzadox, benzfendizone, benzipram, benzobicyclon, benzofenap, benzoylprop, benzthiazuron, bifenox, bilanafos, bispyribac, bromacil, bromobutide, bromoxynil, brompyrazon, butachlor, butafenacil, butamifos, butenachlor, buthidazole, buthiuron, butralin, butroxydim, cacodylic acid, cafenstrole, carfentrazone, chlomethoxyfen, chloramben, chloranocryl, chlorazine, chlorbromuron, chlorbufam, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorthal, chlorthiamid, cinidon-ethyl, cinmethylin, cinosulfuron, cisanilide, clethodim, cliodinate, clomazone, cloransulam, CMA, copper sulfate, CPMF, CPPC, credazine, cresol, cumyluron, cyanatryn, cyanazine, cycloate, cyclosulfamuron, cycloxydim, cycluron, cyperquat, cyprazine, cyprazole, cypromid, daimuron, dalapon, dazomet, delachlor, desmedipham, desmetryn, di-allate, dichlobenil, dichloralurea, dichlormate, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, eglinazine, endothal, epronaz, erbon, esprocarb, ethalfluralin, ethidimuron, ethiolate, ethofumesate, ethoxyfen, ethoxysulfuron, etinofen, etobenzanid, fentrazamide, fenuron, flamprop, flamprop-methyl, flazasulfuron, florasulam, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, furyloxyfen, glufosinate, glufosinate-P, glyphosate, halauxifen, halosafen, halosulfuron, haloxydine, hexaflurate, hexazinone, imazamethabenz, imazamox, imazapic, imazapyr, imazaquin, imazethapyr, imazosulfuron, indanofan, indaziflam, iodosulfuron, ioxynil, ipazine, ipfencarbazone, iprymidam, isocarbamid, isocil, isomethiozin, isonoruron, isopropalin, isoproturon, isouron, isoxaben, isoxaflutole, karbutilate, lactofen, lenacil, linuron, medinoterb, mefenacet, mefluidide, mesoprazine, mesosulfuron, mesotrione, metamitron, metazachlor, metazosulfuron, mefflurazon, methabenzthiazuron, methalpropalin, methazole, methiuron, methometon, methoprotryne, methyldymron, metobenzuron, metobromuron, metolachlor, metosulam, metoxuron, metribuzin, molinate, monalide, monisouron, monolinuron, monuron, morfamquat, naproanilide, napropamide, naptalam, neburon, nicosulfuron, nipyraclofen, nitralin, nitrofen, nitrofluorfen, norflurazon, noruron, orbencarb, orthosulfamuron, oryzalin, oxadiargyl, oxadiazon, oxapyrazon, oxasulfuron, oxaziclomefone, oxyfluorfen, parafluron, pebulate, pendimethalin, penoxsulam, pentanochlor, pentoxazone, perfluidone, pethoxamid, phenisopham, phenmedipham, phenobenzuron, picolinafen, pinoxaden, piperophos, pretilachlor, primisulfuron, procyazine, prodiamine, profluazol, profluralin, profoxydim, proglinazine, prometon, prometryn, propachlor, propanil, propazine, propham, propisochlor, propoxycarbazone, propyrisulfuron, propyzamide, prosulfalin, prosulfocarb, prosulfuron, proxan, prynachlor, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, rhodethanil, rimsulfuron, saflufenacil, S-metolachlor, secbumeton, sethoxydim, siduron, simazine, simeton, simetryn, sulcotrione, sulfallate, sulfentrazone, sulfometuron, sulfosulfuron, sulglycapin, swep, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thiobencarb, tiocarbazil, tralkoxydim, triafamone, tri-allate, triasulfuron, triaziflam, tribenuron, tricamba, triclopyr, tridiphane, trietazine, trifloxysulfuron, trifluralin, triflusulfuron, trifopsime, trihydroxytriazine, trimeturon, tripropindan, tritac, tritosulfuron, vernolate and xylachlor.

### EXAMPLES

In order to aid the understanding of the present invention, the following examples are set forth for the present invention. Those skilled in the art should understand that the described embodiments are only to help understand the present invention, and should not be regarded as specific limitations to the present invention.

### Example 1

Water Dispersible Granules Containing 40% of Sodium Salt of Topramezone:

| Content | Weight % |
|---|---|
| sodium salt of topramezone | 40% |
| naphthalene sulfonate condensed with formaldehyde | 3% |
| (trade name: Tamol NN8906 from BASF) | |
| diatomite | 57% |

The above components were mixed and pulverized with a jet mill to obtain a powder with D90<10 um, and water was added to knead the powder. The kneaded product was granulated by extrusion granulator, dried and sieved to obtain water dispersible granules.

### Example 2

Soluble Granules Containing 50% of Potassium Salt of Topramezone:

| Content | Weight % |
|---|---|
| potassium salt of topramezone | 50% |
| sodium alkylnaphthalenesulfonate | 5% |
| (trade name: Newkalgen BX-C from Takemoto) | |
| lactose monohydrate | 45% |

These substances were processed according to the preparation method of Example 1.

### Example 3

Water Dispersible Granules Containing 80% of Lithium Salt of Topramezone:

| Content | Weight % |
|---|---|
| lithium salt of topramezone | 80% |
| Polycarboxylate | 10% |
| (tradename: Geropon T/36 from Solvay) | |
| organosilicone defoamer | 1% |
| (trade name: SAG 1572, from Momentive) | |
| Kaolin | 9% |

These substances were processed according to the preparation method of Example 1.

### Example 4

Water Dispersible Granules Containing 35% of Ammonium Salt of Topramezone:

| Content | Weight % |
|---|---|
| ammonium salt of topramezone | 35% |
| alkylnaphthalene sulfonate | 8% |
| condensed with formaldehyde | |
| (tradename: Morwet D425 from Nouryon) | |
| white carbon black | 5% |
| (product: SIPERNAT 622S, from Evonik) | |
| diatomite | 52% |

These substances were processed according to the preparation method of Example 1.

### Example 5

Soluble Granules Containing 60% of Sodium Salt of Topramezone:

| Content | Weight % |
|---|---|
| sodium salt of topramezone | 60% |
| sodium polycarboxylate | 5% |
| (trade name: Newkalgen WG-5 from Takemoto) | |
| alkylnaphthalene sulfonate | 3% |
| condensed with formaldehyde | |
| (tradename: Morwet D425 from Nouryon) | |
| ammonium sulfate | 30% |

These substances were processed according to the preparation method of Example 1.

### Example 6

Water Dispersible Granules Containing 45% of Potassium Salt of Topramezone:

| Content | Weight % |
|---|---|
| potassium salt of topramezone | 45% |
| lignosulfonate | 6% |
| (trade name: Reax 88A from Meadwestvaco) | |
| kaolin | 49% |

These substances were processed according to the preparation method of Example 1.

### Comparative Example 1

Water Dispersible Granules Containing 40% of Topramezone:

| Content | Weight % |
|---|---|
| topramezone | 40% |
| naphthalene sulfonate condensed with formaldehyde | 3% |
| (trade name: Tamol NN8906 from BASF) | |
| diatomite | 57% |

These substances were processed according to the preparation method of Example 1.

### Comparative Example 2

Granules Containing 50% of Topramezone:

| Content | Weight % |
|---|---|
| topramezone | 50% |
| sodium alkylnaphthalenesulfonate | 5% |
| (trade name: Newkalgen BX-C from Takemoto) | |
| lactose monohydrate | 45% |

These substances were processed according to the preparation method of Example 1.

### Comparative Example 3

Water Dispersible Granules Containing 80% of Topramezone:

| Content | Weight % |
|---|---|
| topramezone | 80% |
| Polycarboxylate | 10% |
| (tradename: Geropon T/36 from Solvay) | |
| organosilicone defoamer | 1% |
| (trade name: SAG 1572, from Momentive) | |
| Kaolin | 9% |

These substances were processed according to the preparation method of Example 1.

### Comparative Example 4

Water Dispersible Granules Containing 35% of Topramezone:

| Content | Weight % |
|---|---|
| topramezone | 35% |
| alkylnaphthalene sulfonate condensed | 8% |
| with formaldehyde | |
| (tradename: Morwet D425 from Nouryon) | |
| white carbon black | 5% |
| (product: SIPERNAT 622S, from Evonik) | |
| diatomite | 52% |

These substances were processed according to the preparation method of Example 1.

### Comparative Example 5

Granules Containing 60% of Topramezone:

| Content | Weight % |
|---|---|
| topramezone | 60% |
| sodium polycarboxylate | 5% |
| (trade name: Newkalgen WG-5 from Takemoto) | |
| alkylnaphthalene sulfonate | 3% |
| condensed with formaldehyde | |
| (tradename: Morwet D425 from Nouryon) | |
| ammonium sulfate | 32% |

These substances were processed according to the preparation method of Example 1.

### Comparative Example 6

Water Dispersible Granules Containing 45% of Topramezone:

| Content | Weight % |
|---|---|
| topramezone | 45% |
| lignosulfonate | 3% |
| (trade name: Reax 88A from Meadwestvaco) | |
| kaolin | 49% |

These substances were processed according to the preparation method of Example 1.

### Comparative Example 7

Water Dispersible Granules Containing 40% of Sodium Salt of Topramezone:

| Content | Weight % |
|---|---|
| sodium salt of topramezone | 40% |
| Polyoxyethylene tristyryl phenyl | 3% |
| ether ammonium sulfate | |
| (trade name: Soprophor 4D384 from Solvay) | |
| diatomite | 57% |

These substances were processed according to the preparation method of Example 1.

### Comparative Example 8

Soluble Granules Containing 50% of Potassium Salt of Topramezone:

| Content | Weight % |
|---|---|
| potassium salt of topramezone | 50% |
| sodium phenolsulfonate | 5% |
| (trade name: Tamol PP from BASF) | |
| lactose monohydrate | 45% |

These substances were processed according to the preparation method of Example 1.

### Comparative Example 9

Water Dispersible Granules Containing 80% of Lithium Salt of Topramezone:

| Content | Weight % |
|---|---|
| lithium salt of topramezone | 80% |
| EO-PO block polyether | 10% |
| (trade name: Pluronic PE 10500 from BASF) | |
| organosilicone defoamer | 1% |
| (trade name: SAG 1572, from Momentive) | |
| Kaolin | 9% |

These substances were processed according to the preparation method of Example 1.

Disintegration Test

1. Experimental Method

250 ml of standard hard water was added into a 250 ml graduated cylinder, and then 1.0 g product granules were added. When all the granules reached the bottom of the graduated cylinder, the graduated cylinder was turned upside down on the same plane, and the number of inversions before complete disintegration of the granules was observed and recorded.

2. The Experimental Results are as Shown in Table 1:

TABLE 1

| | Number of |
|---|---|
| Sample | inversions (times) |
| Example 1 | 15 |
| Example 2 | 18 |
| Example 3 | 20 |
| Example 4 | 16 |
| Example 5 | 16 |
| Example 6 | 18 |
| Comparative example 1 | 62 |
| Comparative example 2 | 58 |
| Comparative example 3 | 80 |
| Comparative example 4 | 74 |
| Comparative example 5 | 72 |
| Comparative example 6 | 68 |
| Comparative example 7 | 45 |
| Comparative example 8 | 40 |
| Comparative example 9 | 42 |

The results in Table 1 show that the solid herbicidal composition provided by the present invention containing topramezone in the form of salts has a rapid disintegration effect, and basically, the products are completely disintegrated and dispersed within 20 inversion experiments; however, the granular products of Comparative examples 1-6 containing topramezone in a non-salt form need to be inversed at least 50 times, and even 80 times for complete disintegration, which seriously affects a disintegration effect of a product and the convenience for users. Comparative examples 7-9 further illustrate that the solid herbicidal composition containing topramezone in the form of salts cannot achieve a good disintegration effect in combination with dispersants other than the dispersants described in the present invention.

1. A solid herbicidal composition, comprising,
at least one topramezone salt; and
at least one dispersant.

2. The solid herbicidal composition according to claim 1, wherein, the at least one topramezone salt is selected from the group consisting of sodium salt of topramezone, potassium salt of topramezone, lithium salt of topramezone, and ammonium salt of topramezone.

3. The solid herbicidal composition according to claim 1, wherein, the at least one topramezone salt includes sodium salt of topramezone and potassium salt of topramezone.

4. The solid herbicidal composition according to claim 1, wherein, the at least one dispersant is selected from the group consisting of aryl sulfonate salt/ester, alkaryl sulfonate salt/ester, sulfonate salt/ester of their formaldehyde condensates, polycarboxylate, and lignosulfonate.

5. The solid herbicidal composition according to claim 1, wherein, the composition comprises:
35-80 wt % of the at least one topramezone salt; and
1-15 wt % of the at least one dispersant.

6. The solid herbicidal composition according to claim 5, wherein, the herbicidal composition comprises 40-70 wt % of the at least one topramezone salt.

7. The solid herbicidal composition according to claim 5, wherein, the herbicidal composition comprises 2-8 wt % of the at least one dispersant.

8. The solid herbicidal composition according to claim 1, further comprising at least one other functional additive.

9. The solid herbicidal composition according to claim 8, wherein the at least one other functional additive is selected from the group consisting of: a surfactant other than sulfonate salt/ester and carboxylate, a carrier, a binder, a defoamer, a desiccant, a bactericide, a stabilizer, and a colorant.

10. The solid herbicidal composition according to claim 1, further comprising at least one other herbicidal active substance.

11. The solid herbicidal composition according to claim 10, wherein the at least one other herbicidal active substance is selected from the group consisting of: 2,4-D, acetochlor, acifluorfen, aclonifen, alachlor, allidochlor, alloxydim, ametryn, amicarbazone, amidosulfuron, anilofos, atraton, atrazine, azafenidin, azimsulfuron, aziprotryne, barban, beflubutamid, benazolin, benfluralin, benfuresate, bensulfuron, bentazone, benzadox, benzfendizone, benzipram, benzobicyclon, benzofenap, benzoylprop, benzthiazuron, bifenox, bilanafos, bispyribac, bromacil, bromobutide, bromoxynil, brompyrazon, butachlor, butafenacil, butamifos, butenachlor, buthidazole, buthiuron, butralin, butroxydim, cacodylic acid, cafenstrole, carfentrazone, chlomethoxyfen, chloramben, chloranocryl, chlorazine, chlorbromuron, chlorbufam, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorthal, chlorthiamid, cinidon-ethyl, cinmethylin, cinosulfuron, cisanilide, clethodim, cliodinate, clomazone, cloransulam, CMA, copper sulfate, CPMF, CPPC, credazine, cresol, cumyluron, cyanatryn, cyanazine, cycloate, cyclosulfamuron, cycloxydim, cycluron, cyperquat, cyprazine, cyprazole, cypromid, daimuron, dalapon, dazomet, delachlor, desmedipham, desmetryn, di-allate, dichlobenil, dichloralurea, dichlormate, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, eglinazine, endothal, epronaz, erbon, esprocarb, ethalfluralin, ethidimuron, ethiolate, ethofumesate, ethoxyfen, ethoxysulfuron, etinofen, etobenzanid, fentrazamide, fenuron, flamprop, flamprop-methyl, flazasulfuron, florasulam, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, furyloxyfen, glufosinate, glufosinate-P, glyphosate, halauxifen, halosafen, halosulfuron, haloxydine, hexaflurate, hexazinone, imazamethabenz, imazamox, imazapic, imazapyr, imazaquin, imazethapyr, imazosulfuron, indanofan, indaziflam, iodosulfuron, ioxynil, ipazine, ipfencarbazone, iprymidam, isocarbamid, isocil, isomethiozin, isonoruron, isopropalin, isoproturon, isouron, isoxaben, isoxaflutole, karbutilate, lactofen, lenacil, linuron, medinoterb, mefenacet, mefluidide, mesoprazine, mesosulfuron, mesotrione, metamitron, metazachlor, metazosulfuron, mefflurazon, methabenzthiazuron, methalpropalin, methazole, methiuron, methometon, methoprotryne, methyldymron, metobenzuron, metobromuron, metolachlor, metosulam, metoxuron, metribuzin, molinate, monalide, monisouron, monolinuron, monuron, morfamquat, naproanilide, napropamide, naptalam, neburon, nicosulfuron, nipyraclofen, nitralin, nitrofen, nitrofluorfen, norflurazon, noruron, orbencarb, orthosulfamuron, oryzalin, oxadiargyl, oxadiazon, oxapyrazon, oxasulfuron, oxaziclomefone, oxyfluorfen, parafluron, pebulate, pendimethalin, penoxsulam, pentanochlor, pentoxazone, perfluidone, pethoxamid, phenisopham, phenmedipham, phenobenzuron, picolinafen, pinoxaden, piperophos, pretilachlor, primisulfuron, procyazine, prodiamine, profluazol, profluralin, profoxydim, proglinazine, prometon, prometryn, propachlor, propanil, propazine, propham, propisochlor, propoxycarbazone, propyrisulfuron, propyzamide, prosulfalin, prosulfocarb, prosulfuron, proxan, prynachlor, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, rhodethanil, rimsulfuron, saflufenacil, S-metolachlor, secbumeton, sethoxydim, siduron, simazine, simeton, simetryn, sulcotrione, sulfallate, sulfentrazone, sulfometuron, sulfosulfuron, sulglycapin, swep, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thiobencarb, tiocarbazil, tralkoxydim, triafamone, tri-allate, triasulfuron, triaziflam, tribenuron, tricamba, triclopyr, tridiphane, trietazine, trifloxysulfuron, trifluralin, triflusulfuron, trifopsime, trihydroxytriazine, trimeturon, tripropindan, tritac, tritosulfuron, vernolate, and xylachlor.

12. The solid herbicidal composition according to claim 1, wherein the composition is in the form of water dispersible granules.

13. The solid herbicidal composition according to claim 1, wherein the at least one topramezone salt is sodium salt of topramezone; the at least one dispersant is naphthalene sulfonate condensed with formaldehyde; and further including diatomite.

14. The solid herbicidal composition according to claim 1, wherein the at least one topramezone salt is potassium salt of topramezone; the at least one dispersant is sodium alkylnaphthalenesulfonate; and further including lactose monohydrate.

15. The solid herbicidal composition according to claim 1, wherein the at least one topramezone salt is lithium salt of topramezone; the at least one dispersant is polycarboxylate; and further including kaolin.

16. The solid herbicidal composition according to claim 1, wherein the at least one topramezone salt is ammonium salt of topramezone; the at least one dispersant is alkylnaphthalene sulfonate condensed with formaldehyde; and further including white carbon black and diatomite.

17. The solid herbicidal composition according to claim 1, wherein the at least one topramezone salt is sodium salt of topramezone; the at least one dispersant is sodium polycarboxylate and alkylnaphthalene sulfonate condensed with formaldehyde; and further including ammonium sulfate.

18. The solid herbicidal composition according to claim 1, wherein the at least one topramezone salt is potassium salt of topramezone; the at least one dispersant is lignosulfonate; and further including kaolin.

19. The solid herbicidal composition according to claim 1 further including at least one carrier selected from the group consisting of: diatomite, lactose monohydrate, kaolin, white carbon black, and ammonium sulfate.

20. The solid herbicidal composition according to claim 1, wherein the at least one topramezone salt is selected from the group consisting of: sodium salt of topramezone, potassium salt of topramezone, lithium salt of topramezone, and ammonium salt of topramezone; and the at least one dispersant is selected from the group consisting of: naphthalene sulfonate condensed with formaldehyde, sodium alkylnaphthalenesulfonate, polycarboxylate, alkylnaphthalene sulfonate condensed with formaldehyde, sodium polycarboxylate, alkylnaphthalene sulfonate condensed with formaldehyde, and lignosulfonate.
